(19) United States
(12) Patent Application Publication
(10) Pub. No.: US 2002/0138447 A1
(43) Pub. Date: Sep. 26, 2002

(54) System and method for updating personal financial information

(75) Inventor: Rabindranath Dutta, Austin, TX (US)

Correspondence Address: Joseph T. Van Leeuwen, P. O. Box 81641, Austin, TX, 78708-1641, US

(73) Assignee: International Business Machines Corporation, Armonk, NY

(21) Appl. No.: 09/817,112

(22) Filed: Mar. 26, 2001

(51) Int. Cl. H04K 1/00; H04L 9/00; G06F 17/60

(52) U.S. Cl. 705/70; 235/379; 705/67

(57) ABSTRACT

A system and method for updating personal financial information at one or more online financial institutions. The user uses a financial software program on a client computer system to update or edit contact information pertaining to the user. The user is asked whether he wishes to send the updated contact information to one or more financial institutions. If the user wishes to send the information to one or more financial institutions, he selects the financial institutions to which the data will be sent and selects a command button to send the data. The data, which may be encrypted, is sent to the selected financial institutions over a computer network, such as the Internet. The institutions validate the user request using information such as user identifiers and passwords. Validated requests are processed and the client contact information maintained by the financial institutions is updated.

### BACKGROUND OF THE INVENTION

1. Technical Field

The present invention relates in general to a method and system for updating personal financial information. More particularly, the present invention relates to a system and method for using client based personal financial software to transmit changes to the user's address and contact information to one or more online financial institutions.

2. Description of the Related Art

Personal financial software, such as Intuit's Quicken™ software and Microsoft's Money™ software, are quite popular with consumers and small businesses that need to keep track of income and expenses. The first personal financial software programs were little more than computer based checkbook registers, enabling the user to keep their checkbook and savings account registers on their computers and having the software perform simple mathematical functions to help the user balance the account.

Over time, these software programs evolved into complete money management packages enabling users to track not only checkbooks and savings accounts, but to also track a variety of loans and investments as well as providing sophisticated money management tools such as budgeting, net worth analyses, reporting, and graphing.

With the increased popularity of the Internet, many consumers access bank accounts and other accounts from their home computer using a simple Internet connection. Banks, brokerages, and other financial institutions provide Internet sites, also known as Web sites, so that their customers can access accounts and other information. These Web sites often allow the user to check account balances and recent transactions, apply for loans, buy and sell stocks, bonds and other securities, and read about promotions and services offered by the financial institutions. Indeed, consumers often choose a financial institution based largely on the quality and functions provided by the institution's online Web site. Some financial institutions, such as online brokerages, are exclusively Web-based without any traditional “brick and mortar” branch offices.

Personal financial software vendors have also incorporated Internet capabilities in their software packages. Often, these services allow a customer to pull the data from a Web site. For general data, such as stock quotes, a publicly accessible Web site can be used. However, for the customer's personal data a secured site is generally preferred. In a secured site, the customer often provides a user identifier and a password to access the customer's data. The user identifiers and corresponding passwords can be stored by some financial software packages in order to retrieve the customer's information quickly and without having the customer re-type the user identifier and password each time he accesses the Web site. More secure implementations, however, may require the user to enter either both the user identifier and password or at least the password before accessing the customer's account at the online financial institution.

Customers often have many financial institutions and each of the institutions may have an online presence. The proliferation of financial institutions has largely stemmed from the increased availability of such institutions as well as increased competition between institutions for customers. For example, online brokers often provide a cash incentive to new customers to entice the customers to deposit money and open an account with the broker. Because of such incentives, many customers wind up with many online accounts.

Certain customer information is common to each of the online financial institutions. For example, the customer's name, address and telephone number is usually maintained by each financial institution. In addition, many financial institutions keep track of customer's fax numbers and email addresses. If a customer moves or changes his contact information and fails to notify a financial institution, important documents and other things mailed to the customer may not be received. Because of the increase in the number of financial accounts owned by modern day users, notifying each of the financial institution regarding a change in contact information is often challenging.

What is needed, therefore, is a way to notify online financial institutions regarding contact information changes without having to manually contact each institution individually.

### SUMMARY

It has been discovered that a client-based personal financial software program can be used to notify financial institutions regarding customer contact changes and have such changes be reflected in the financial institution's records. The user keeps his personal contact information in a data area accessible to the personal financial software. When the client contact information is changed, the personal financial software program asks the user whether he wishes to report the changes to one or more financial institutions.

Information about the financial institutions is also maintained in a data store accessible by the personal financial software program. The information includes a name identifying the financial institution along with an online address used to contact the financial institution. The online address may be a Web address, an email address, or a modem telephone directory used to access the financial institution's network. Additionally, the financial institution information may include the client's user identifier and the client's password.

The user selects one or more financial institutions that have been configured at the client computer system. When the user requests to make the changes, the software sends the updated client contact information to each of the selected financial institutions.

The financial institutions each receive a client information update request from the client computer. Software running on the financial institution's online site validates the client using the client's identifier and password or other information that it used to identify the client on the financial institution's online site. If the client is validated, the update information is received and used to update the financial institutions client data. In addition, the financial institution may return a message to the user indicating whether the update request was successfully processed.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a network diagram showing client contact information being sent to financial institutions and used to update client data files;

FIG. 2 is a user interface sequence showing the interface presented to the user by a personal financial software program;

FIG. 3 is a component diagram showing the components used to update client information on both the client computer system and the financial institution's computer system;

FIG. 4 is a flowchart showing the processing performed on the client computer system;

FIG. 5 is a flowchart showing the processing performed by the financial institution's computer system; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

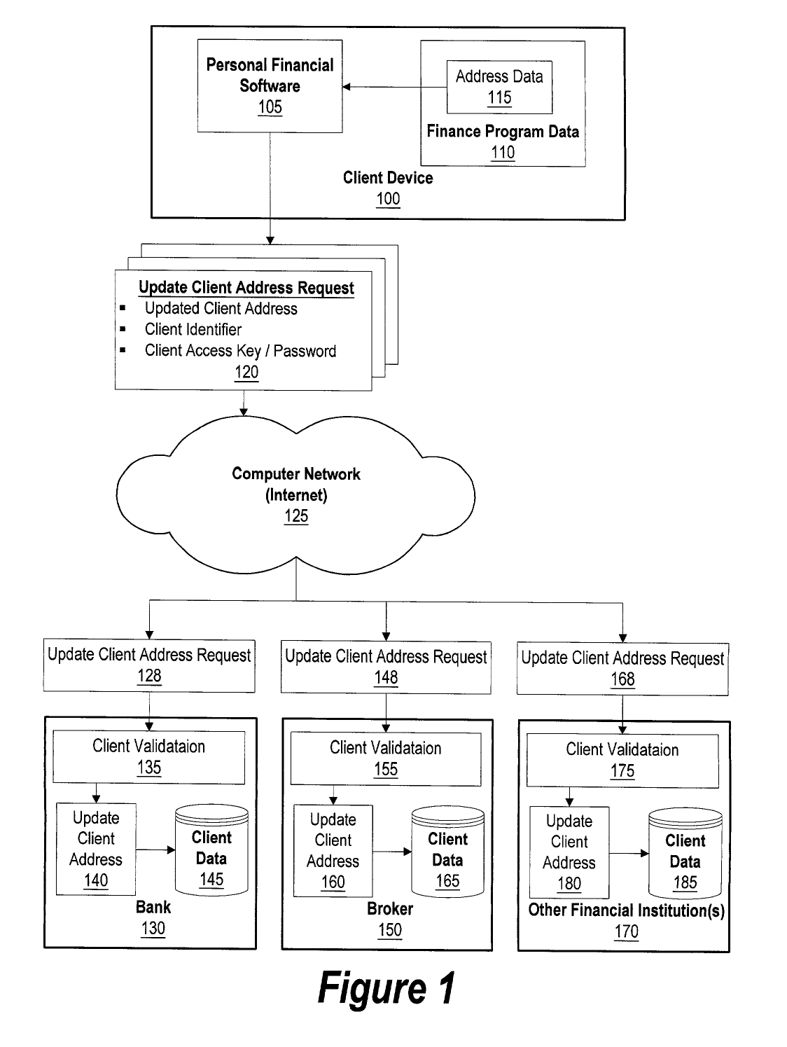

FIG. 1 is a network diagram showing client contact information being sent to financial institutions and used to update client data files. Client device 100 may be a personal computer, a handheld computing device, or any other computing device capable of running personal financial software 105. Personal financial software 105 is used by the user to keep track of and analyze the user's personal financial data. As used herein, the terms “user” and “client” are used interchangeably and means the user of client device 100 who is also the client of one or more financial institutions.

Personal financial software 105 maintains finance program data 110 which includes information provided by the user. Finance program data 110 includes information regarding the financial institutions used by the user, including online addresses and access information pertaining to such institutions. Finance program data 110 also includes address data 115. Address data 115 includes contact information regarding the user. This contact information may include the user's name, address, phone number(s), fax number, email account(s), and any other information pertaining to contacting the user. This information may also include identification information corresponding to the user such as a social security number. In addition, address data 115 need only be accessible to personal financial software 105. For example, the data could be stored in a contact area in a separate program, such as a personal information manager (“PIM”), provided by a separate program such as Microsoft's Outlook™.

When the user wishes to update his contact information maintained by one or more financial institutions, personal financial software 105 transmits one or more update requests 120 to one or more financial institutions. Each of the update requests 120 is electronically addressed to a particular financial institution. Each request includes the client's updated contact information, a client identifier identifying the client to the financial, and an access code, password, or other information used to verify the identity of the user. Update requests 120 are transmitted through computer network 125 to the respective financial institutions as determined by the electronic address. While the Internet is a preferred computer network, other computer networks may also be used. For example, the electronic address may include a phone number that the client computer system uses to dial and transmit the information directly to the financial institution's computer network. The electronic address used with the update requests may be a Uniform Resource Locator (URL) corresponding to the financial institution's web site or may be an email address, or any other address used to uniquely identify the financial institution.

In the example shown, the user has requested that at least three financial institutions receive an update request. Bank 130 receives update request 128, broker 150 receives update request 148, and other financial institution(s) 170 receive update request 168. Each of the financial institutions includes a process to validate the client (bank 130 includes client validation process 135, broker 150 includes client validation process 155, and other financial institution(s) 170 includes client validation process 175). The client validation process uses a client identifier and a client access key or password to ensure that the update request is being received from the client and not an imposter or other individual. Each of the financial institutions also includes a process to update the client contact information (bank 130 includes update client address process 140, broker 150 includes update client address process 160, and other financial institution(s) include update client address process 180). The update client information processes each update a client data store maintained by the respective financial institution (bank 130 maintains client data store 145, broker 150 maintains client data store 165, and other financial institution(s) 170 maintains client data store 185). The data stores may include a flat file, a database, or other files used to store client information. The client data files are each updated with the updated client contact information.

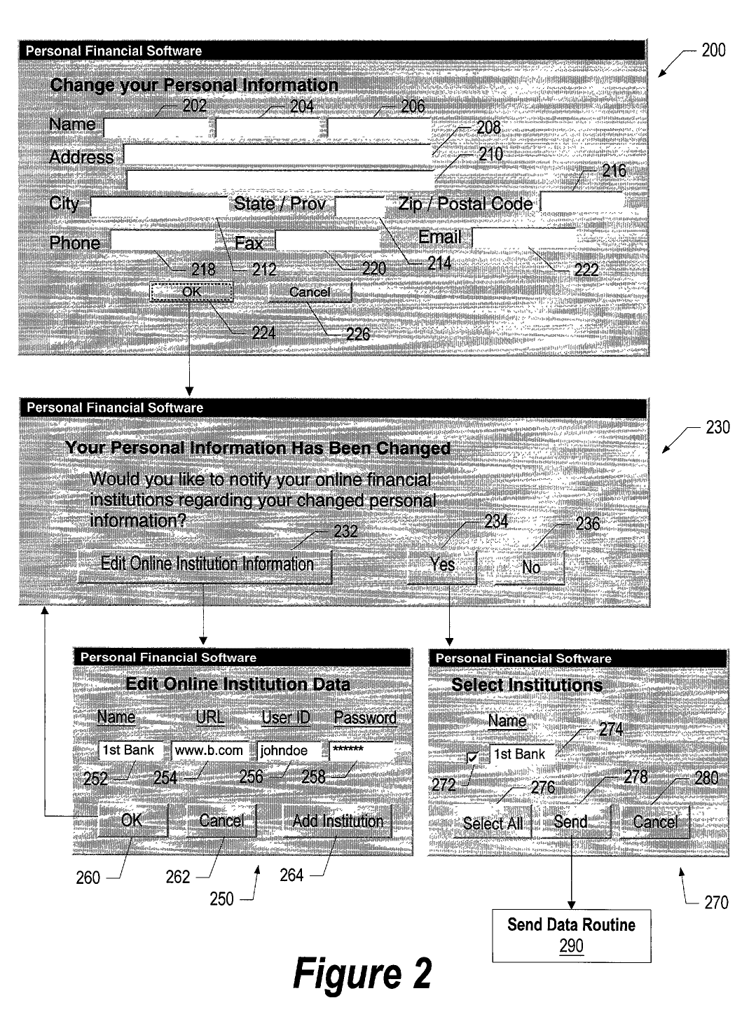

FIG. 2 is a user interface sequence showing the interface presented to the user by a personal financial software program. The user enters or updates his personal information using personal information update screen 200. Personal information update screen 200 includes fields to enter or edit the client's information. First name field 202 is used to enter or update the client's first name. Middle name field 204 is used to enter or update the client's middle name. Last name field 206 is used to enter or update the client's last name. Two address line fields (field 208 and 210) are provided for the user to enter or update the client's mailing address. City field 212 is used to enter or update the client's city. Likewise, state field 214 and zip field 216 are used to enter or update the client's state and zip code, respectively. Phone field 218 is used to enter or update the phone number the client wishes to include for telephone contact and fax field 220 is used to enter or update a fax number if the client has a fax number. Finally, email field 222 is used to enter or update an email address corresponding to the client. When the entries or updates are completed, the user presses “OK” command button 224 to move to the next screen. To abort changes to the user's personal information, the user presses “Cancel” command button 226.

When the user presses “OK” command button 224, notification screen 230 appears notifying the user that his personal information has been changed and offering to notify online financial institutions regarding the change. If the user realizes that his online financial information is not current, he selects “Edit Online Institution Information” command button 232 which causes edit online institution data screen 250 to appear.

Edit online institution data screen 250 provides fields for the user to manage his online institutions. One or more financial institution name fields 252 are provided to identify the financial institution. The user can enter a name that he will recognize as applying to the particular financial institution. Electronic address field 254 is provided for the user to enter in an electronic address, such as a URL, that is used to contact the financial institution's computer system. User identifier field 256 is used to enter the identifier corresponding to the user and established with the financial institution. Password field 258 is used to enter a password that corresponds with the entered user identifier at the financial institution's computer system. The user selects “Add Institution” command button 264 to add additional financial institutions. To cancel changes, the user selects “Cancel” command button 262 which returns to notification screen 230 without recording any changes made by the user on edit online institution data screen 250. To confirm changes made by the user on edit online institution data screen 250, the user selects “OK” command button 260 and returns back to notification screen 230.

In response to the question posed in notification screen 232, the user either presses “YES” command button 234 or “NO” command button 236. If the user presses “NO” command button 236, the changes are made to the user's personal information but no institutions are notified (at this time) of the changes. The user may wish to notify selected financial institutions at a later time, perhaps after establishing additional user identifiers and passwords with one or more additional financial institutions. If the user presses “YES” command button 234, then select institutions screen 270 appears.

Select institutions screen 270 allows the user to select one or more financial institutions using checkbox 272 located beside the corresponding financial institution(s). One or more name fields 274 appears to identify the financial institution. If numerous financial institutions appear on select institutions screen 270, the user can select “Select All” command button 276 in order to mark each checkbox 272. “Send” command button 278 is used to invoke send data routine 290. Send data routine 290 packages the personal information and sends it to the selected financial institutions' computer systems using the provided institution data. Finally, “Cancel” command button is used to cancel select institutions screen 270 and return to notification screen 230, perhaps if the user realizes that one or more financial institutions need to be added or edited before sending.

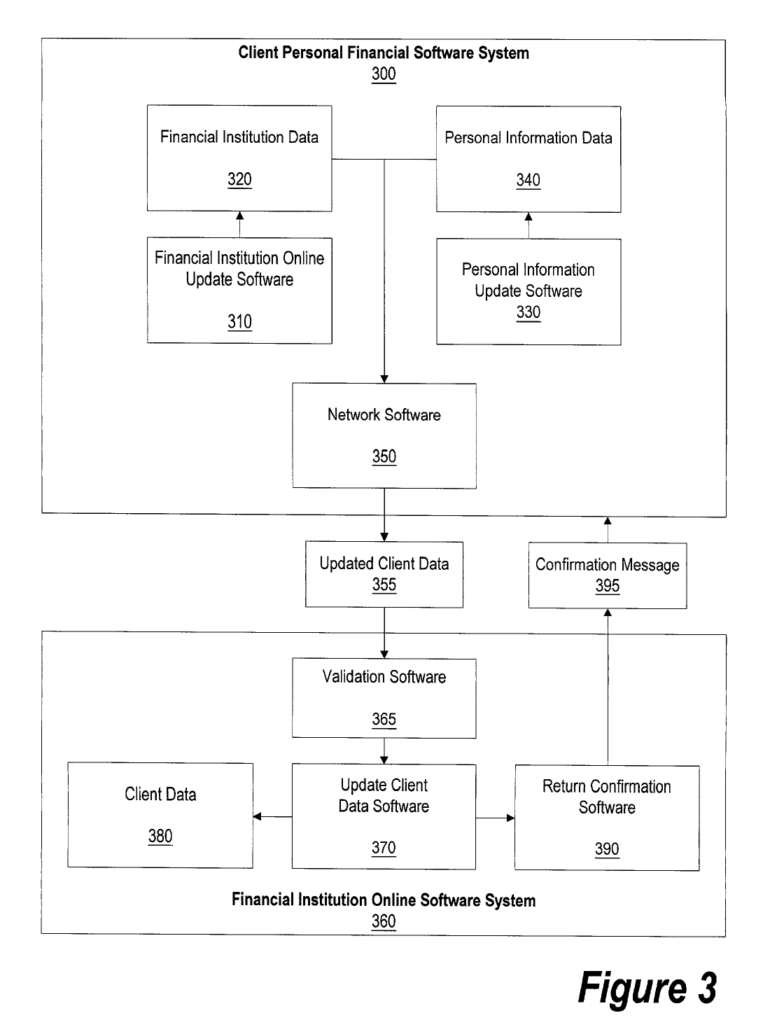

FIG. 3 is a component diagram showing the components used to update client information on both the client computer system and the financial institution's computer system. Client personal financial software system 300 resides on the client's computing device. Financial institution online update software 310 is used to edit information pertaining to financial institutions. This information is stored as financial institution data 320. Personal information update software 330 is used to edit information pertaining to the client's personal contact information. This contact information is stored as personal information data 340. Network software 350 is used to package personal information data 340 and send to one or more financial institutions using financial institution data 320. Network software 350 sends updated client data packet 355 to financial institution online software system 360.

Financial institution online software system 360 resides on the financial institution's computer system. It receives updated client data packet 355 sent from the client computing device. Validation software 365 is used to analyze updated client data packet 355 and validate the client. Validation may be performed using a user identifier and password included in updated client data 355. In addition, updated client data packet 355 may be encrypted using public-key/private-key encryption. Using public-key/private-key encryption, updated client data packet 355 is encrypted using a private key corresponding to the client. Only the client has the private key. Other computer systems, including the financial institution's computer system, can obtain the client's public key which will decipher data packet 355. Deciphering the data using the public key verifies that the data was encrypted using the client's private key, thus providing a digital signature verifying that indeed the client was the computing device that encrypted the data. Other established public key security mechanisms, such as the use of digital certificates, and third party certificate revocation list servers and associated certificate authorities can also be used to verify the identity of the client.

If the client is validated, update client data software 370 is used to update client data 380, such as the client database maintained by the financial institution. Return confirmation software 390 is used to send confirmation message 395 back to the client. For enhanced security, confirmation message 395 may be sent using both the old contact information and the updated contact information. In this manner, if the user had not moved and an unauthorized person sent the update request from the client's computing device, then the client would receive the confirmation message and be able to take corrective action to prevent the unauthorized person from redirecting the client's financial information.

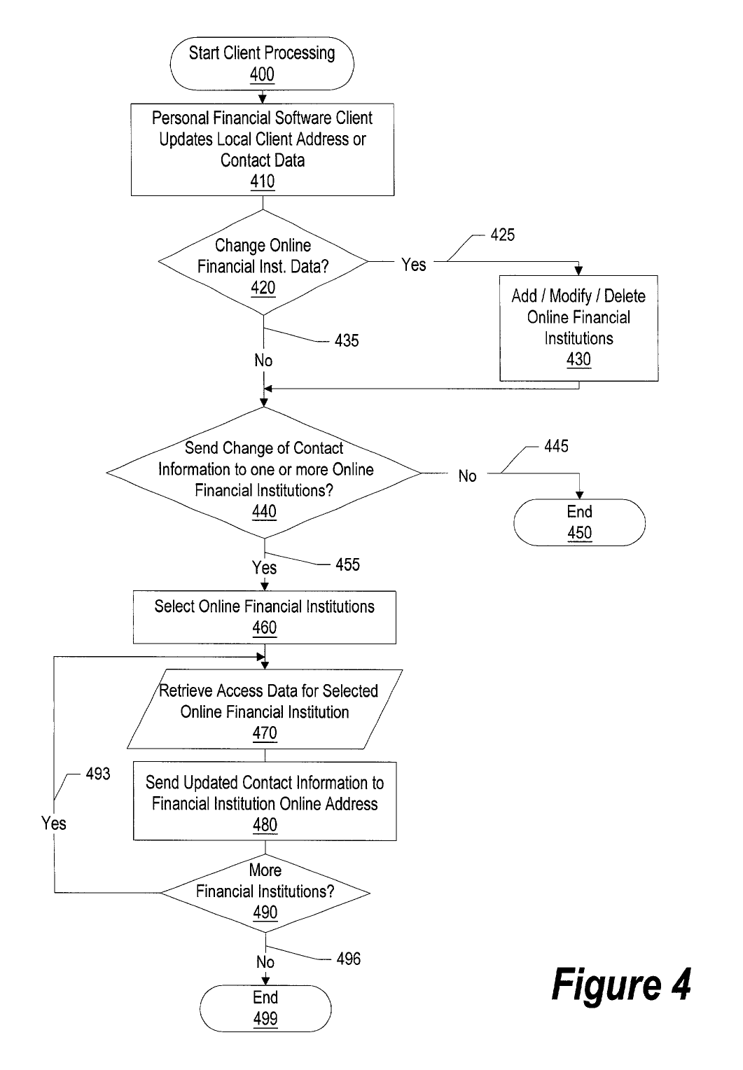

FIG. 4 is a flowchart showing the processing performed on the client computer system. Processing commences at 400 whereupon the client updates his personal contact information (step 410). A determination is made as to whether the user wishes to update his financial institution data (decision 420). Decision 420 may be in response to the user selecting an option to edit the data corresponding to his online financial institutions. If the user wishes to change online financial institution information, decision 420 branches to “yes” branch 425 and the user adds, modifies, or deletes online financial institution information (step 430), otherwise decision 420 branches to “no” branch 435.

A decision is made as to whether the user wishes to send the updated personal contact information to one or more financial institutions (decision 440). If the user does not wish to send the updated data to one or more financial institutions, “no” branch 445 is taken and processing ends at 450. On the other hand, if the user wishes to send updated information to one or more financial institutions, decision 440 branches to “yes” branch 455 whereupon the user selects one or more financial institutions to which the data should be sent (step 460). The access data (Web address, user identifier, password, etc.) for the first selected financial institution is retrieved (input 470). An update request is created and sent using the retrieved financial institution information and the updated client information (step 480). A determination is made whether there are more selected financial institutions to which the updated client information needs to be sent (decision 490). If there are more institutions, decision 490 branches to “yes” branch 493 which loops back to process the next selected financial institution. This processing continues until there are no more selected financial institutions to process, whereupon decision 490 branches to “no” branch 496 and processing ends at 499.

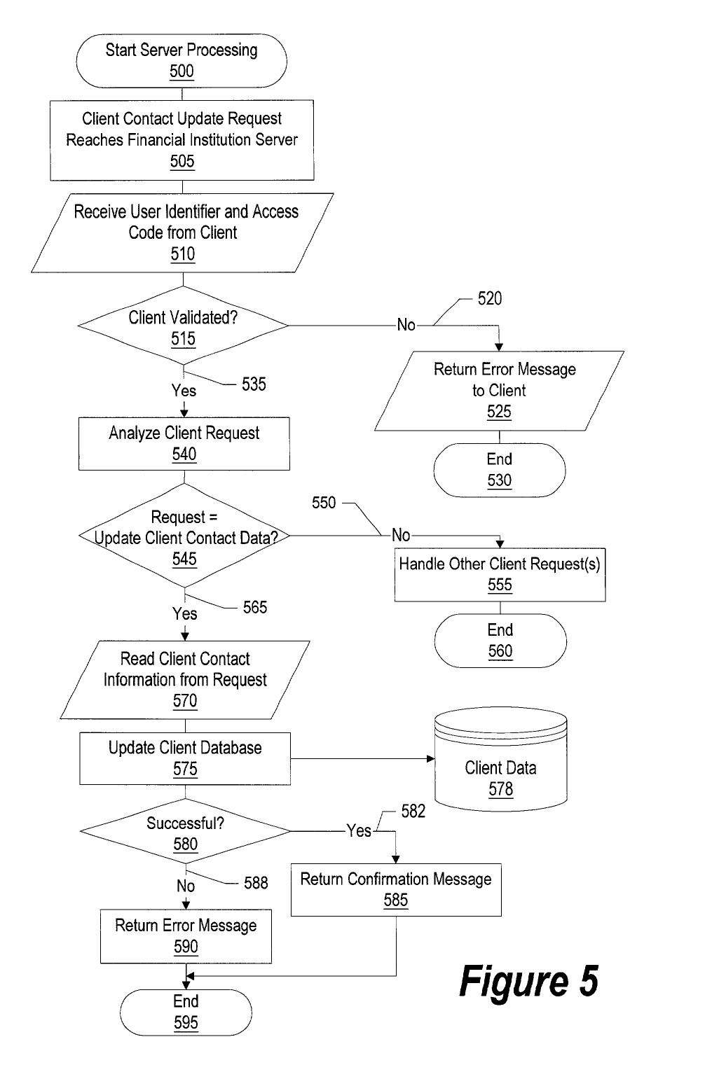

FIG. 5 is a flowchart showing the processing performed by the financial institution's computer system. Processing commences at 500 whereupon the financial institution's computer system receives an update request from a client (step 505). A user identifier and password corresponding to the client is received from the received information (input 510). This information is used to validate the client. A determination is made as to whether the user identifier and password are valid (decision 515). If they are not valid, decision 515 branches to “no” branch 520 whereupon an error message is returned to the client (output 525) and processing of the update request ends at 530.

If the user identifier and password are valid, decision 515 branches to “yes” branch 535 whereupon the received client request is analyzed (step 540). A determination is made as to whether the request is to update the client's contact information (decision 545). If the request is not to update the client's contact information, decision 545 branches to “no” branch 550 whereupon the request is passed to another routine to handle the client's request (step 555) and processing ends at 560.

If the client's request is to update his client information, decision 545 branches to “yes” branch 565 whereupon the updated client contact information is retrieved from the update request (input 570). The retrieved information is used to update (step 575) client data 578. A determination is made whether the update request was processed successfully (decision 580). If the request was processed successfully, decision 580 branches to “yes” branch 582 whereupon a confirmation message is returned to the user (step 585). On the other hand, if the request was not processed successfully, decision 580 branches to “no” branch 588 whereupon and error message is returned to the client. Processing then ends at 595.

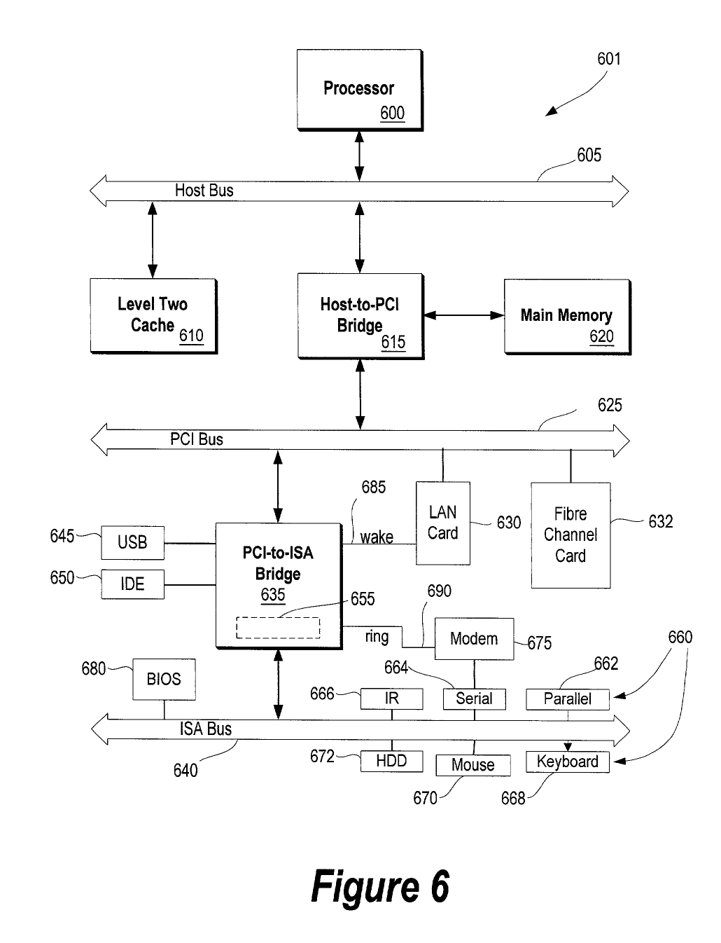

FIG. 6 illustrates information handling system 601 which is a simplified example of a computer system capable of performing the operations at either the client or server computer systems. Computer system 601 includes processor 600 which is coupled to host bus 605. A level two (L2) cache memory 610 is also coupled to the host bus 605. Host-to-PCI bridge 615 is coupled to main memory 620, includes cache memory and main memory control functions, and provides bus control to handle transfers among PCI bus 625, processor 600, L2 cache 610, main memory 620, and host bus 605. PCI bus 625 provides an interface for a variety of devices including, for example, LAN card 630. PCI-to-ISA bridge 635 provides bus control to handle transfers between PCI bus 625 and ISA bus 640, universal serial bus (USB) functionality 645, IDE device functionality 650, power management functionality 655, and can include other functional elements not shown, such as a real-time clock (RTC), DMA control, interrupt support, and system management bus support. Peripheral devices and input/output (I/O) devices can be attached to various interfaces 660 (e.g., parallel interface 662, serial interface 664, infrared (IR) interface 666, keyboard interface 668, mouse interface 670, and fixed disk (HDD) 672) coupled to ISA bus 640. Alternatively, many I/O devices can be accommodated by a super I/O controller (not shown) attached to ISA bus 640.

BIOS 680 is coupled to ISA bus 640, and incorporates the necessary processor executable code for a variety of low-level system functions and system boot functions. BIOS 680 can be stored in any computer readable medium, including magnetic storage media, optical storage media, flash memory, random access memory, read only memory, and communications media conveying signals encoding the instructions (e.g., signals from a network). In order to attach computer system 601 to another computer system to copy files over a network, LAN card 630 is coupled to PCI-to-ISA bridge 635. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the invention described herein, this computer system is simply one example of a computer system. Those skilled in the art will appreciate that many other computer system designs are capable of performing the copying process described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of updating client contact data, said method comprising:
selecting one or more financial institutions;
retrieving access information corresponding to the selected financial institutions;
packaging the client contact data with data from the retrieved access information forming one or more client contact update requests; and
sending one of the client contact update requests to each of the selected financial institutions using data from the retrieved access information.

2. The method as described in claim 1 further comprising:
encrypting the packaged client contact data.

3. The method as described in claim 1 wherein the client contact data includes at least one of a client name, a client address, a client phone number, a client facsimile number, and a client email address.

4. The method as described in claim 1 wherein the access information includes at least one of a user identifier, a password, and a financial computer electronic address.

5. The method as described in claim 1 wherein the packaging is performed in response to a user requesting that the client contact data be transmitted to one or more financial institutions.

6. The method as described in claim 1 further comprising:
receiving one of the client contact update requests from a client computer, the received client contact update request being at a computer corresponding to one of the financial institutions;
validating the client update request; and
updating a nonvolatile storage area corresponding to the client based on the client contact data included in the client contact update request.

7. The method as described in claim 6 further comprising:
sending a confirmation message to the client computer in response to the updating.

8. The method as described in claim 1 further comprising:
encrypting at least one of the client contact update requests with a private key corresponding to a client, wherein the encrypted request is decipherable using a public key corresponding to the client.

9. An information handling system comprising:
one or more processors;
a memory accessible by the processors;
a nonvolatile storage device accessible by the processors;
a network interface accessible by the processors;,
a client contact update tool for updating client contact data, the client contact update tool including:
means for selecting one or more financial institutions;
means for retrieving access information corresponding to the selected financial institutions;
means for packaging the client contact data with data from the retrieved access information forming one or more client contact update requests; and
means for sending one of the client contact update requests to each of the selected financial institutions over the network interface using data from the retrieved access information.

10. The information handling system as described in claim 9 wherein the client contact data includes at least one of a client name, a client address, a client phone number, a client facsimile number, and a client email address.

11. The information handling system as described in claim 9 further comprising:
means for encrypting at least one of the client contact update requests with a private key corresponding to a client, wherein the encrypted request is decipherable using a public key corresponding to the client.

12. The information handling system as described in claim 9 further comprising:
means for connecting the information handling system to a computer network through the network interface; and
means for sending the client contact update requests to network addresses corresponding to each of the selected financial institutions.

13. A computer program product stored on a computer operable medium for updating client contact data, said computer program product comprising:
means for selecting one or more financial institutions;
means for retrieving access information corresponding to the selected financial institutions;
means for packaging the client contact data with data from the retrieved access information forming one or more client contact update requests; and
means for sending one of the client contact update requests to each of the selected financial institutions using data from the retrieved access information.

14. The computer program product as described in claim 13 further comprising:
means for encrypting the packaged client contact data.

15. The computer program product as described in claim 13 wherein the client contact data includes at least one of a client name, a client address, a client phone number, a client facsimile number, and a client email address.

16. The computer program product as described in claim 13 wherein the access information includes at least one of a user identifier, a password, and a financial computer electronic address.

17. The computer program product as described in claim 13 wherein the means for packaging is performed in response to a user requesting that the client contact data be transmitted to one or more financial institutions.

18. The computer program product as described in claim 13 further comprising:
means for receiving one of the client contact update requests from a client computer, the received client contact update request being at a computer corresponding to one of the financial institutions;
means for validating the client update request; and
means for updating a nonvolatile storage area corresponding to the client based on the client contact data included in the client contact update request.

19. The computer program product as described in claim 18 further comprising:
means for sending a confirmation message to the client computer in response to the updating.

20. The computer program product as described in claim 13 further comprising:
means for encrypting at least one of the client contact update requests with a private key corresponding to a client, wherein the encrypted request is decipherable using a public key corresponding to the client.
